(19) United States
(12) Patent Application Publication
(10) Pub. No.: US 2008/0106127 A1
(43) Pub. Date: May 8, 2008

(54) SECURE LIFE VEST CONTAINER

(75) Inventors: Ray Hough, Maulden (GB); Martin Ian Dickinson, Little Billing (GB)

Correspondence Address: ADAMS INTELLECTUAL PROPERTY LAW, P.A., Suite 2350 Charlotte Plaza, 201 South College Street, CHARLOTTE, NC, 28244, US

(73) Assignee: BE AEROSPACE, INC., Wellington, FL (US)

(21) Appl. No.: 11/691,237

(22) Filed: Mar. 26, 2007

Related U.S. Application Data
(60) Provisional application No. 60/743,800, filed on Mar. 27, 2006.

(51) Int. Cl. B60N 2/44

(52) U.S. Cl. 297/188.08

(57) ABSTRACT

The present invention provides a life vest container for containing a life vest at an aircraft seat. The life vest container includes a housing that defines a storage volume that is dimensioned to receive the life vest. An opening is formed in the housing that is dimensioned to provide access to the storage volume. A cover is dimensioned to generally block the opening and is movable from a first position wherein the storage volume is not accessible through the opening. A tamper-evident sealing material is positioned between the cover and the housing for sealing the cover to the housing when the cover is in the first position. The sealing material is configured to be irreversibly changed in a distinct manner when the cover is moved from the first position.

### BACKGROUND OF THE INVENTION

This invention relates generally to aircraft and more particularly to a life vest container assembly for an aircraft seat unit. Commercial passenger aircraft include safety devices for use by passengers in case of a crash or ditching, for example flotation devices. Some flotation devices are simple members of buoyant material. Inflatable life vests, packed in a folded condition, are also used. Such life vests must be stored in a manner and location so that they will not be damaged during normal operations but can be easily and quickly put into use during an emergency. Accordingly, many modern aircraft seating units include a pouch or container underneath the seat cushion where the life vest is readily accessible to the passenger.

Unfortunately, life vests stored in such an easily accessible location are subject to tampering and theft. Furthermore, it is possible for terrorists to insert weapons or other illegal items into the container. Recent government regulations also require airlines to visibly inspect each life vest pouch prior to operation of the aircraft. Using prior art life vest pouch designs, this regulation requires each pouch to be opened, inspected, closed and then resealed. This requires a significant amount of man-hours to inspect each aircraft before every flight, which is an enormous financial drain for the airlines.

Accordingly, there is a need for a storage container for a life vest which protects the life vest until use that is configured to indicate whether tampering has occurred and to provided for periodic inspection of the life vest.

### BRIEF SUMMARY OF THE INVENTION

This need is met by the present invention, which provides a life vest container, including a hollow housing defining a storage volume adapted to receive a flotation device, and a cover attached to the container and moveable between a closed position in which the storage volume is inaccessible, and an open position in which the storage volume is accessible. At least a portion of the housing or the cover is sufficiently light-transmissive to allow observation of the condition of a flotation device disposed within the storage volume.

Accordingly, one aspect of the present invention provides a life vest container for containing a life vest at an aircraft seat. The life vest container includes a housing that defines a storage volume that is dimensioned to receive the life vest. An opening is formed in the housing that is dimensioned to provide access to the storage volume. A cover is dimensioned to generally block the opening and is movable from a first position wherein the storage volume is not accessible through the opening. A tamper-evident sealing material is positioned between the cover and the housing for sealing the cover to the housing when the cover is in the first position. The sealing material is configured to be irreversibly changed in a distinct manner when the cover is moved from the first position.

According to another aspect of the present invention, the cover is movable from the first position to a second position, and the storage volume is accessible through the opening when the cover is in the second position.

According to another aspect of the present invention, at least a portion of the cover is formed of a non-opaque material such that the storage volume is viewable from outside of the housing.

According to another aspect of the present invention, a life vest positioned within the storage volume can be seen from outside of the housing.

According to another aspect of the present invention, the tamper evident sealing material is configured to undergo a physical change when the cover is moved from the first position.

According to another aspect of the present invention, the tamper evident sealing material is configured to undergo a chemical change when the cover is moved from the first position.

According to another aspect of the present invention, the container includes a flexible strap having a fixed first end and a movable second end, wherein the strap is positioned such that when the movable first end is pulled, the cover moves from the first position and the tamper evident sealing material is irreversibly changed.

According to another aspect of the present invention, the container includes a flexible strap having a fixed first end and a movable second end, wherein the strap is positioned such that when the movable second end is moved, a life vest positioned within the storage volume moves and causes the cover to move from the first position.

According to another aspect of the present invention, the housing is attached to an aircraft seat.

According to another aspect of the present invention, there is provided a method of retaining a life vest in tamper evident condition at an aircraft seat. A housing is provided that defines a storage volume dimensioned to receive the life vest, wherein the housing has an opening defined therein for providing access to the storage volume, a cover dimensioned to block the opening, and a flexible strap. A life vest is placed within the storage volume such that the strap is threaded underneath the life vest, around an end of the life vest positioned away from the opening, and through the opening. The cover is positioned such that at least a portion of the cover extends beyond the opening and over the housing. A sealing material is positioned between the cover and the housing. The housing and the cover are contacted with the sealing material such that the cover is attached to the housing in a first position and the opening is blocked.

### BRIEF DESCRIPTION OF THE DRAWINGS

The subject matter that is regarded as the invention may be best understood by reference to the following description taken in conjunction with the accompanying drawing figures in which:

FIG. 1 is a perspective view of a life vest container constructed according to the present invention;

FIG. 2 is an exploded view of the life vest container of FIG. 1;

FIG. 3 is a perspective view of the life vest container of FIG. 1 mounted to a seat frame, with a life vest stowed therein;

FIG. 4 is a perspective view of the life vest container of FIG. 1 mounted to a seat frame, showing a first step in deploying a life vest therefrom;

FIG. 5 is a perspective view of the life vest container of FIG. 1 mounted to a seat frame, with a life vest being withdrawn therefrom;

FIG. 6 is a top view of the life vest container of FIG. 1 mounted to a seat frame;

FIG. 7 is a bottom view of the life vest container of FIG. 1 mounted to a seat frame;

FIG. 8 is a side cross-sectional view of the life vest container of FIG. 1 mounted to a seat frame;

FIG. 9 is an enlarged perspective view of a portion of the life vest container of FIG. 1;

FIG. 10 is a perspective view of an exemplary tamper-evident sealing material; and

FIG. 11 is a perspective view of the life vest container of FIG. 1 attached to an aircraft seat.

### DETAILED DESCRIPTION OF THE INVENTION

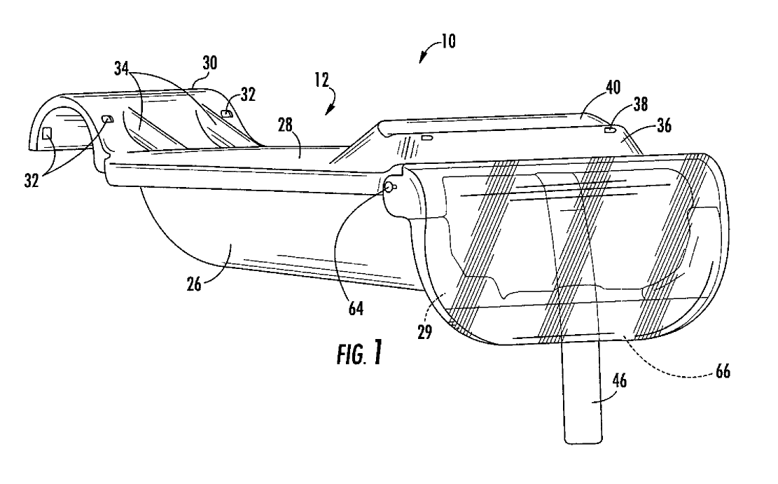

Referring to the drawings wherein identical reference numerals denote the same elements throughout the various views, an exemplary life vest container 10 constructed in accordance with the present invention is shown in FIGS. 1 and 2. The life vest container 10 includes a hollow housing 12 defining a storage volume and having an opening 14. The housing 12 may be formed from any lightweight, impermeable material such as plastic. One known suitable material is fire-retardant polycarbonate. The housing 12 has a top wall 16, a bottom wall 18, opposed sidewalls 20 and 22, respectively, and a back wall 24. In the illustrated example, the housing 12 comprises a lower shell 26 which defines the bottom wall 18, sidewalls 20 and 22, and back wall 24, and a complementary upper shell 28 which defines the top wall 16. The upper and lower shells 26 and 28 are vacuum-molded as separate components and secured together using a suitable method such as adhesives, snap-fit, thermal bonding, or mechanical fasteners. A flange 29 is disposed adjacent the opening 14. If desired, the housing 12 may be formed as a unitary component, for example by injection molding in a known manner.

The top wall 16 extends aft beyond the back wall 24 and forms a curved rear mounting bracket 30 which has rear mounting holes 32 therein. Stiffeners 34 extend between the top wall 16 and the rear mounting bracket 30. A raised front mounting boss 36 with front mounting holes 38 extends upwards from the top wall 16. The front mounting boss 36 has a transverse, concave depression 40 formed at its upper end. Spaced-apart hinge members 42 are disposed on the side walls 20 and 22 adjacent the opening 14.

In the illustrated example, the housing 12 is opaque, but if desired, all or part of the housing 12 made be made translucent or transparent.

A known type of life vest 44 is disposed inside the housing 12. Typically, such life vests 44 are packaged in protective overwrapping which seals and protects the life vest 44 until use. In the illustrated example, the life vest 44 is in the form of a rectangular solid with rounded corners, but other shapes are known, and the shape of the housing 12 may be chosen to fit the particular type of life vest 44 used.

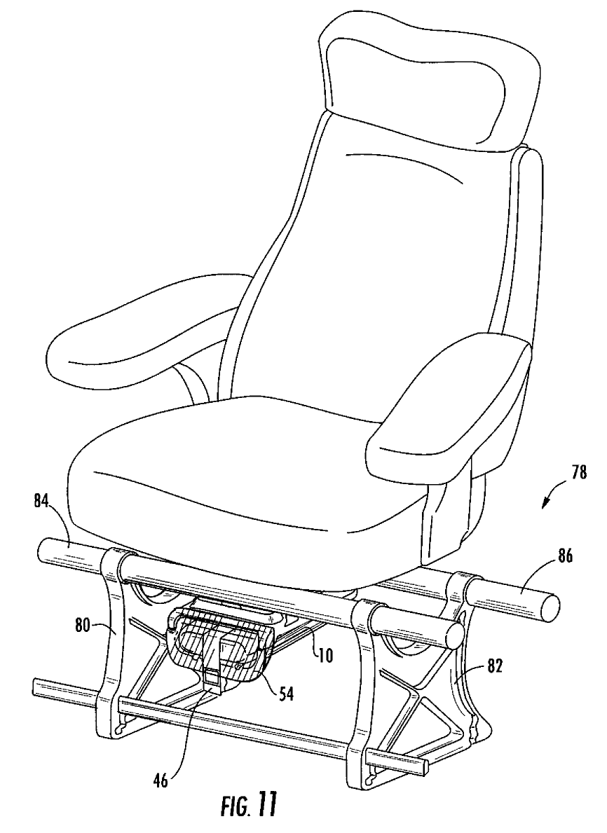

A flexible deployment strap 46 with first and second ends 48 and 50 is disposed inside the housing 12. As shown in FIG. 9, the second end 50 is secured to the housing 12 in a suitable fashion, for example by using a rivet 52 driven through the sidewall of a well 53 formed in the bottom wall 18. The deployment strap 46 is then threaded aftwards underneath the life vest 44, up and over the back end of the life vest 44, forwards over the top of the life vest 44, and finally downwards over the front of the life vest 44, with its first end 48 hanging free.

A rigid cover 54 is attached to the housing 12 so that it can swing between an open position and a closed position. The cover 54 is a generally planar, substantially rigid member constructed of plastic or similar material and has an outer face 56 and an inner face 58. An upstanding inner ridge 60 extends around at least a portion of the perimeter of the inner face 58 and serves to help locate the cover 54 in the closed position. Hinge members 62 complementary to hinge members 42 of the housing 12 are disposed at the opposed top corners of the cover 54. In the illustrated example, all or part of the cover 54 is translucent or transparent, that is, non-opaque, to a sufficient degree to allow viewing of the life vest 40 inside, and also to discourage theft of the life vest 40, since it would be immediately obvious if it were missing from the housing 12. The cover 54 is attached to the housing 12 by aligning their respective hinge members 62 and 42 and then inserting one or more hinge pins 64 (see FIG. 1) through the hinge members 62 and 42.

In the closed position, shown in FIG. 1, the lower portion of the cover 54 is secured to the flange 29 on the housing 12 using a sealing material 66 positioned between the cover 54 and the housing 12. The deployment strap 46 passes downwards between the cover 54 and the flange 29, with a portion thereof hanging free.

FIG. 10 shows an exemplary tamper-evident sealing material 66. The exemplary sealing material 66 includes a first layer 68 and a second layer 70. Each of the first and second layers 68 and 70 has an internal surface 72 and an external surface 74. When the sealing material 66 is ready for use, the internal surfaces 72 are adhered together as part of an integral structure. In the illustrated example, each of the external surfaces 74 is coated with a suitable adhesive (not shown). The properties of the sealing material 66 are chosen such that, when two objects are sealed together with the sealing material 66, and an attempt is made to separate the two objects, the first and second layers 68 and 70 will remain attached to their respective objects and will pull apart from each other. When the first layer 68 is pulled away from the second layer 70, the internal surfaces 72 are irreversibly changed in a distinct manner, thus giving evidence of tampering. In the illustrated example, a pattern of indicia 76 such as the word “void” is visible in one or both of the first and second layers 68 and 70. Any sealing material 66 which is capable of indicating tampering may be used with the life vest container 10. Many sealing materials of this type are commercially available, which operate in various ways. For example, a physical or a chemical change or both may occur in the sealing material to evidence tampering. The exact principle of operation is not important for the present invention, so long as tampering is disclosed. If any tampering does occur, the changed condition of the sealing material 66 will be visible through the cover 54.

The sealing material 66 and the cover 54 could be attached to the flange 29 in a number of different ways. For example, the sealing material 66 could be provided with adhesive already applied to both sides, in which case the sealing material 66 could be simply pressed onto the flange 29 and the interior of the cover 64. Alternatively, a separate adhesive (not shown), for example a brush-on or sprayable adhesive, could be applied to the cover 54, sealing material 66, and life vest container 10 before assembly.

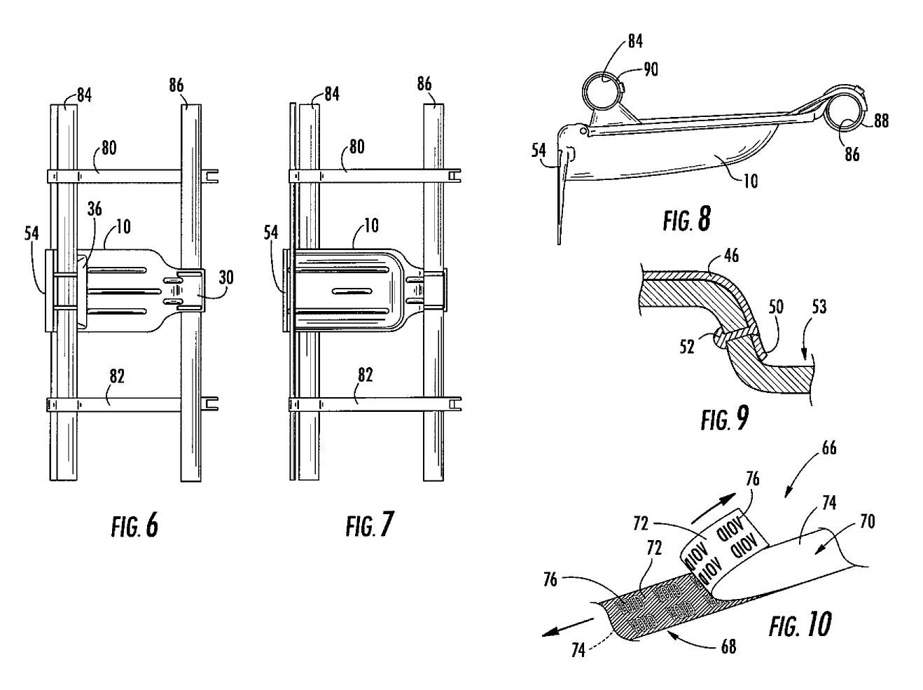

FIGS. 6-8, and 11 illustrate how the life vest container 10 may be mounted to an aircraft passenger seat frame 78, which supports one or more seats of conventional construction (not shown). In the particular embodiment shown, the seat frame 78 includes leg modules 80 and 82, which are connected by forward and aft laterally-extending transverse beams 84 and 86. It is noted that the exact location and the particular mounting method is not critical to the operation of the present invention and may be altered as desired to suit a particular application. The rear mounting bracket 30 is placed against the aft beam 86. Rear mounting straps 88 are then passed through the rear mounting holes 32, around the aft beam 86, and pulled tight. The rear mounting straps 88 may be similar to plastic cable ties of a known type. The front mounting boss 36 is placed against the front beam 84. Front mounting straps 90 of the same type as the rear mounting straps 88 are then passed through the front mounting holes 38, around the front beam 84, and pulled tight. Using this mounting method, the packing and sealing of the life vest container 10 is completely independent from its mounting to the seat frame 78. It is therefore possible to pre-package life vest containers 10 with life vests, and to seal and inspect them, and then mount them in the aircraft with minimal labor and cost.

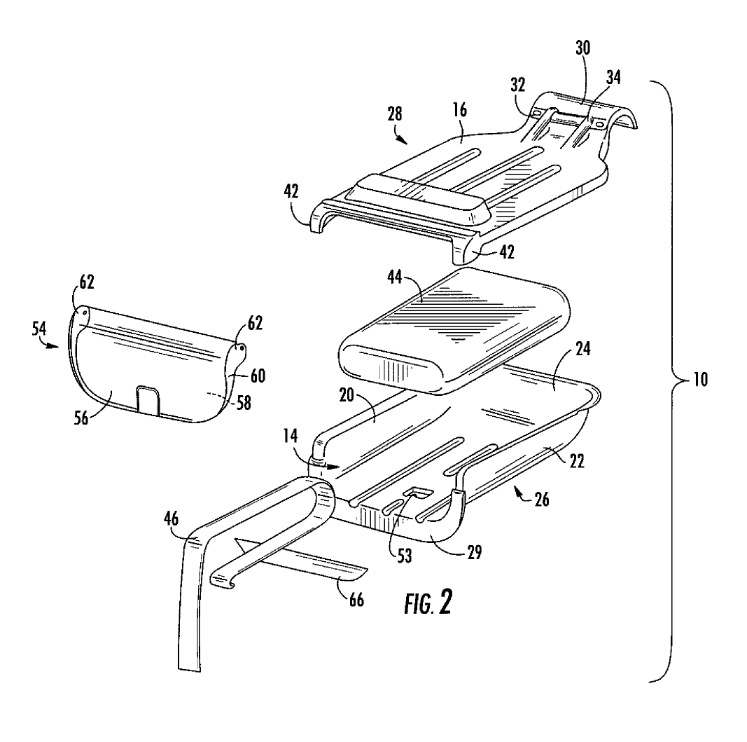

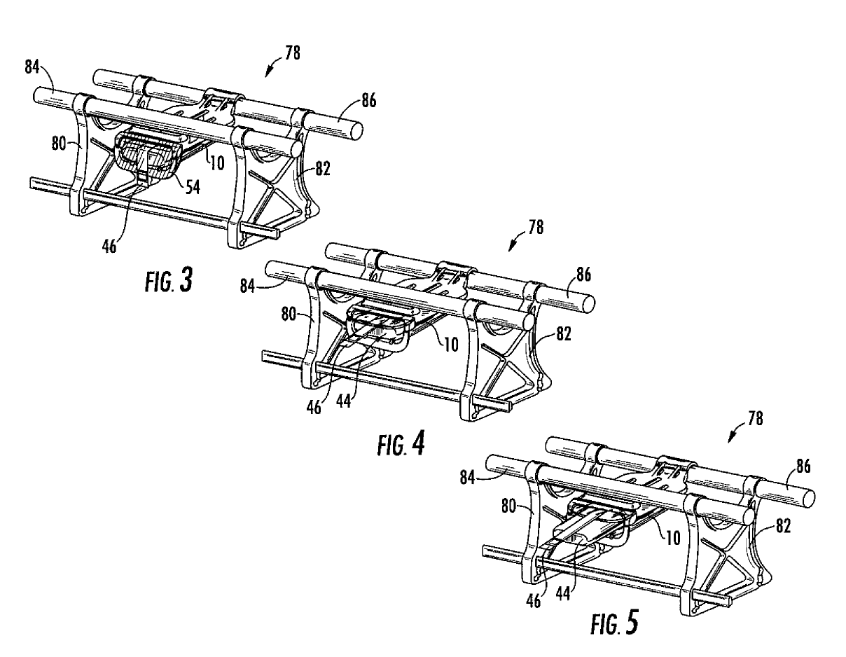

The use of the life vest container 10 is shown in FIGS. 3-5. The closed cover 54 (FIG. 3) is opened by pulling forwards on the deployment strap 46 to separate the cover 54 from the sealing material and swing it upwards, which also causes the sealing material 66 to change as described above. (see FIG. 4). Continued forward tension on the deployment strap 46 causes it to partially pull the life vest 44 from the life vest container 10 so that it can be easily grasped by a passenger (see FIG. 5).

The foregoing has described a secure life vest container assembly including a hollow container, and a cover attached to the container with a tamper-evident sealing material. While specific embodiments of the present invention have been described, it will be apparent to those skilled in the art that various modifications thereto can be made without departing from the spirit and scope of the invention. Accordingly, the foregoing description of the preferred embodiment of the invention and the best mode for practicing the invention are provided for the purpose of illustration only and not for the purpose of limitation.

What claimed is:

1. A life vest container for containing a life vest at an aircraft seat, the life vest container comprising:
a housing;
a storage volume defined by the housing and dimensioned to receive the life vest;
an opening formed in the housing and being dimensioned to provide access to the storage volume;
a cover dimensioned to generally block said opening, the cover being movable from a first position wherein the storage volume is not accessible through the opening; and
a tamper-evident sealing material positioned between the cover and the housing for sealing the cover to the housing when the cover is in the first position, wherein the sealing material is configured to be irreversibly changed in a distinct manner when the cover is moved from the first position.

2. A life vest container according to claim 1, wherein the cover is movable from the first position to a second position, and the storage volume is accessible through the opening when the cover is in the second position.

3. A life vest container according to claim 1, wherein at least a portion of the cover is formed of a non-opaque material such that the storage volume is viewable from outside of the housing.

4. A life vest container according to claim 1, wherein a life vest positioned within the storage volume can be seen from outside of the housing.

5. A life vest container according to claim 1, wherein the tamper evident sealing material is configured to undergo a physical change when the cover is moved from the first position.

6. A life vest container according to claim 5, wherein the tamper evident sealing material is configured to undergo a chemical change when the cover is moved from the first position.

7. A life vest container according to claim 1, further comprising a flexible strap having a fixed first end and a movable second end, wherein the strap is positioned such that when the movable first end is pulled, the cover moves from the first position and the tamper evident sealing material is irreversibly changed.

8. A life vest container according to claim 1, further comprising a flexible strap having a fixed first end and a movable second end, wherein the strap is positioned such that when the movable second end is moved, a life vest positioned within the storage volume moves and causes the cover to move from the first position.

9. A life vest container according to claim 1, wherein the housing is attached to an aircraft seat.

10. A method of retaining a life vest in tamper evident condition at an aircraft seat, the method comprising the steps of:
providing a housing that defines a storage volume dimensioned to receive the life vest, wherein the housing has an opening defined therein for providing access to the storage volume, a cover dimensioned to block the opening, and a flexible strap;
placing a life vest within the storage volume such that the strap is threaded underneath the life vest, around an end of the life vest positioned away from the opening, and through the opening;
positioning the cover such that at least a portion of the cover extends beyond the opening and over the housing;
positioning a sealing material between the cover and the housing; and
contacting the housing and the cover with the sealing material such that the cover is attached to the housing in a first position and the opening is blocked.

11. A method as defined in claim 10, wherein when the cover is moved from the first position, the sealing material undergoes an irreversible change.

12. A method as defined in claim 11, wherein the tamper evident sealing material is configured to undergo a physical change when the cover is moved from the first position.

13. A method as defined in claim 11, wherein the tamper evident sealing material is configured to undergo a chemical change when the cover is moved from the first position.

14. A method as defined in claim 10, wherein at least a portion of the cover is formed of a non-opaque material such that the storage volume is viewable from outside of the housing.

15. A method as defined in claim 10, wherein in a life vest positioned within the storage volume can be seen from outside of the housing.

16. A method as defined in claim 10, wherein the flexible strap has a fixed first end and a movable second end that extends from the storage volume, wherein the strap is positioned such that when the movable first end is pulled, the cover moves from the first position and the tamper evident sealing material is irreversibly changed.

17. A life vest container according to claim 1, further comprising a flexible strap having a fixed first end and a movable second end, wherein the strap is positioned such that when the movable second end is moved, a life vest positioned within the storage volume moves and causes the cover to move from the first position.

18. A life vest container according to claim 1, wherein the housing is attached to an aircraft seat.
